(19) United States
(12) Patent Application Publication
(10) Pub. No.: US 2021/0101408 A1
(43) Pub. Date: Apr. 8, 2021

(54) WHEEL RECONDITIONING APPARATUS

(71) Applicant: AG INC., Taichung City (TW)

(72) Inventor: Cheng-Tzu Lai, Taichung City (TW)

(73) Assignee: AG INC., Taichung City (TW)

(21) Appl. No.: 16/743,021

(22) Filed: Jan. 15, 2020

(30) Foreign Application Priority Data
Oct. 7, 2019 (TW) 108213270

(51) Int. Cl. B60B 30/08

(52) U.S. Cl. CPC B60B 30/08; B23B 5/28; B60B 2310/228; B60B 2320/126

(57) ABSTRACT

A wheel reconditioning apparatus includes an upright post connected to a base seat, a transverse carrier, a first drive unit, a cutter unit, a second drive unit and a working table. The upright post has a support front surface. The transverse carrier is disposed slideably on the support front surface. The first drive unit is mounted between the upright post and the transverse carrier to move the transverse carrier. The cutter unit is disposed slideably on a carrier front surface of the transverse carrier. The second drive unit is connected between the transverse carrier and the cutter unit to drive the cutter unit. The working table is mounted to the base seat and is oriented toward the cutter unit.

### CROSS-REFERENCE TO RELATED APPLICATION

This application claims priority to Taiwanese Patent Application No. 108213270, filed on Oct. 7, 2019.

### FIELD

The disclosure relates to a reconditioning apparatus, and more particularly to a wheel reconditioning apparatus.

### BACKGROUND

FIG. 1 shows a wheel reconditioning apparatus disclosed in Taiwanese Patent No. I580520, which includes a base 10A, a horizontal sliding seat 20A disposed atop and slidable horizontally along the base 10A, a vertical sliding seat 30A disposed in front of and slidable vertically along the horizontal sliding seat 20A, a cutter turret 40A disposed on the vertical sliding seat 30A, and a working table 60A mounted to a fixture 50A to recondition a wheel (not shown) on the working table 60A. Because the horizontal sliding seat 20A is disposed slidably atop the base 10A, the cutter turret 40A has a relatively large distance (L) from a junction of the horizontal sliding seat 20A and the base 10A so that a relatively large bending moment is created at the cutter turret 40A. This adversely affects machining accuracy of the wheel reconditioning apparatus.

Likewise, similar problems exist in a wheel reconditioning apparatus as disclosed in Chinese Patent Publication Numbers CN203751460U and CN200954545Y.

### SUMMARY

Therefore, an object of the disclosure is to provide a wheel reconditioning apparatus that can improve machining accuracy.

Accordingly, a wheel reconditioning apparatus of the disclosure includes a support unit, a transverse carrier, a first drive unit, a cutter unit, a second drive unit, and a working table. The support unit includes a base seat, and an upright post integrally connected atop the base seat and extending along a first direction. The upright post has a support front surface extending along the first direction. The transverse carrier is disposed transversely of and slideably along the first direction on the support front surface, and has a carrier front surface spaced apart from the support front surface. The first drive unit is mounted between the upright post and the transverse carrier to drive the transverse carrier to move along the first direction. The cutter unit is disposed slideably along a second direction transverse to the first direction on the carrier front surface. The second drive unit is connected between the transverse carrier and the cutter unit to drive the cutter unit to move along the second direction. The working table is mounted to the base seat and is oriented toward the cutter unit.

### BRIEF DESCRIPTION OF THE DRAWINGS

Other features and advantages of the disclosure will become apparent in the following detailed description of the embodiment with reference to the accompanying drawings, of which:

FIG. 1 shows a conventional wheel reconditioning apparatus;

FIG. 2 is a perspective view of a wheel reconditioning apparatus according to an embodiment of the present disclosure;

FIG. 3 is a front view of the embodiment;

FIG. 4 is a sectional view taken along line IV-IV of FIG. 3;

FIG. 5 is a sectional view taken along line V-V of FIG. 3; and

FIG. 6 is a sectional view taken along line VI-VI of FIG. 3.

### DETAILED DESCRIPTION

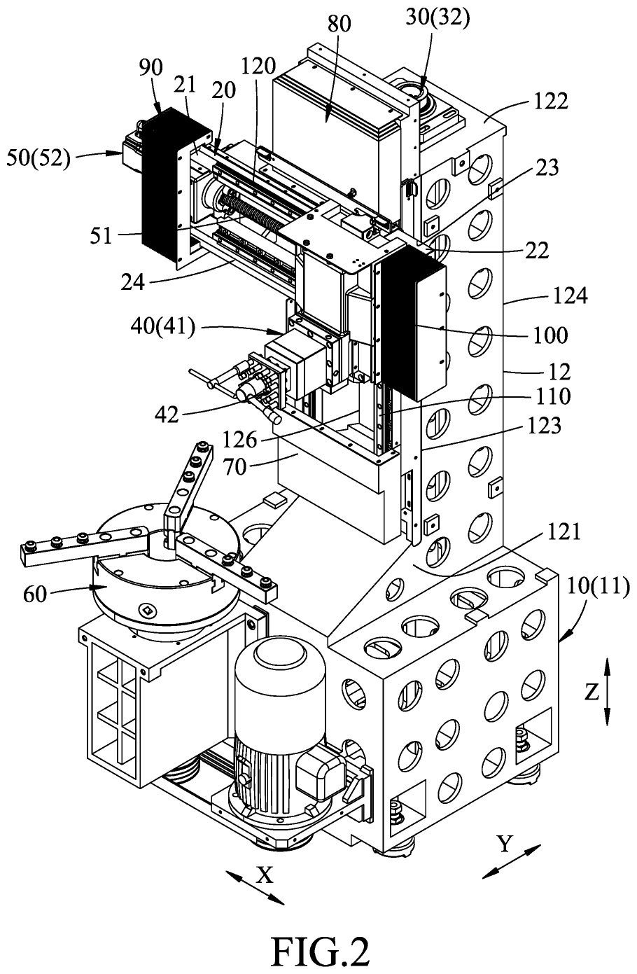

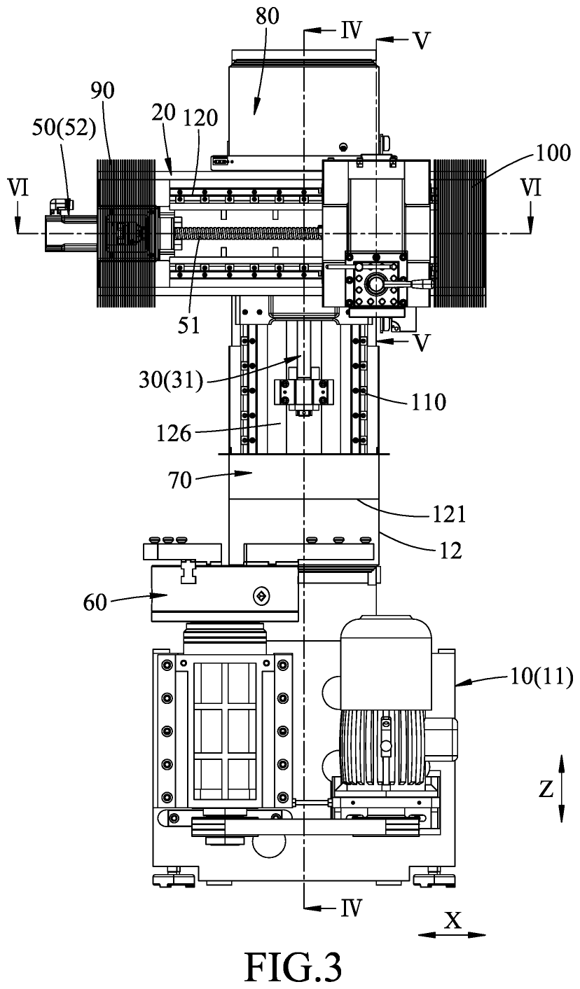

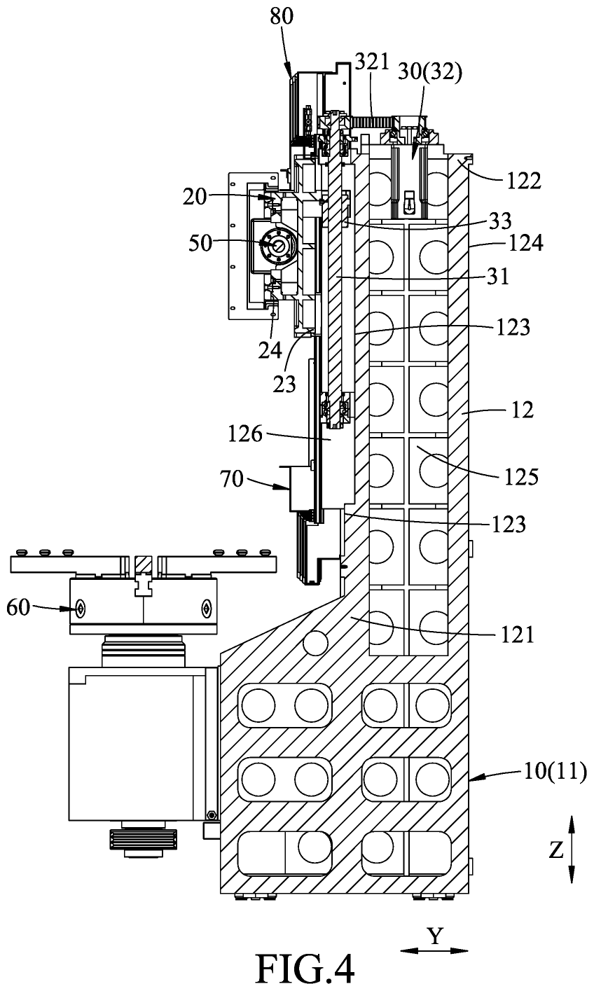

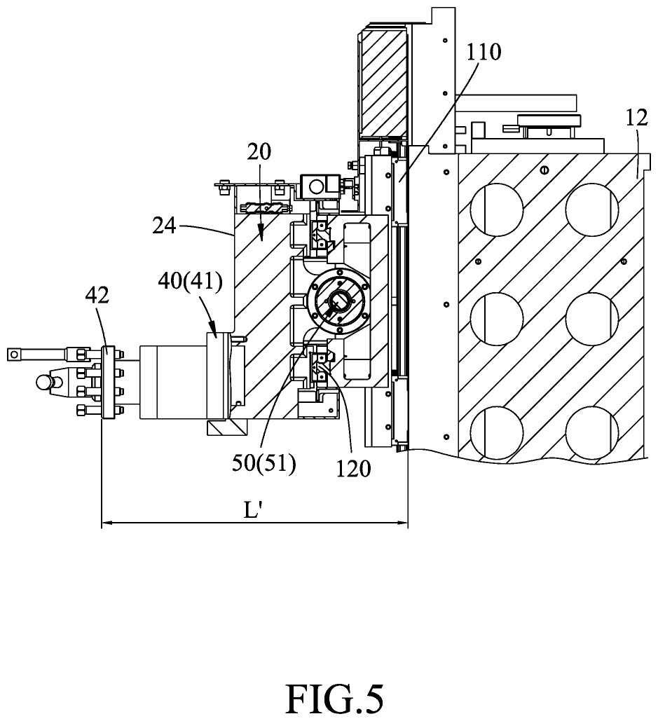

Referring to FIGS. 2 to 5, a wheel reconditioning apparatus according to an embodiment of the disclosure is shown to include a support unit 10, a transverse carrier 20, a first drive unit 30, a cutter unit 40, a second drive unit 50, a working table 60, a bottom extendable and contractable cover 70, a top extendable and contractable cover 80, a left extendable and contractable cover 90, a right extendable and contractable cover 100, a first guide rail unit 110 disposed between the support unit 10 and the transverse carrier 20, and a second guide rail unit 120 disposed between the transverse carrier 20 and the cutter unit 40.

The support unit 10 includes a base seat 11, and an upright post 12 integrally connected atop the base seat 11 and extending along a first direction (Z). The upright post 12 is hollow and has a post bottom portion 121 connected to the base seat 11, a post top portion 122 opposite to the post bottom portion 121 along the first direction (Z), a support front surface 123 extending along the first direction (Z) from the post bottom portion 121 to the post top portion 122, a support rear surface 124 opposite to the support front surface 123, an accommodating space 125 formed between the support front and rear surfaces 123, 124 and opening upwardly, and an indentation portion 126 indented into the support front surface 123.

The transverse carrier 20 is disposed transversely of and slideably along the first direction (Z) on the support front surface 123, and has a left lateral portion 21, a right lateral portion 22 opposite to the left lateral portion 21 along a second direction (X) transverse to the first direction (Z), a carrier rear surface 23 proximate to the support front surface 123 and extending from the left lateral portion 21 to the right lateral portion 22, and a carrier front surface 24 opposite to the carrier rear surface 23 and spaced apart from the support front surface 123.

The first drive unit 30 is mounted between the upright post 12 and the transverse carrier 20 to drive the transverse carrier 20 to move along the first direction (Z). The first drive unit 30 includes a first threaded guide rod 31 disposed along the first direction (Z) on the upright post 12 proximately of the support front surface 123, a first motor 32 mounted to the upright post 12 to drive rotation of the first threaded guide rod 31 through a belt 321, and a first nut 33 threadedly connected to the first threaded guide rod 31 and fixed to the transverse carrier 20. In this embodiment, the first threaded guide rod 31 is mounted in the indentation portion 126. The first motor 32 is mounted within the accommodating space 125.

The cutter unit 40 is disposed slideably along the second direction (X) on the carrier front surface 24, and includes a main seat 41 situated on the front side of the transverse carrier 20, and a cutter turret 42 mounted to the main seat 41 and spaced apart from the carrier front surface 24 along a third direction (Y) transverse to the first and second direction (Z, X).

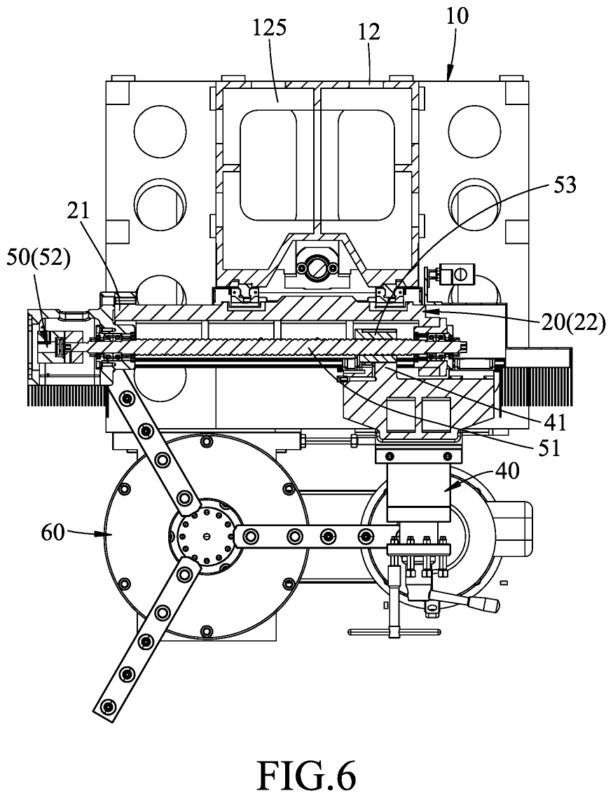

Referring to FIG. 6, the second drive unit 50 is connected between the transverse carrier 20 and the cutter unit 40 to drive the cutter unit 40 to move along the second direction (X). The second drive unit 50 includes a second threaded guide rod 51 disposed along the second direction (X) on the transverse carrier 20, a second motor 52 mounted to the transverse carrier 20 to drive rotation of the second threaded guide rod 51, and a second nut 53 threadedly connected to the second threaded guide rod 51 and fixedly connected to the main seat 41 of the cutter unit 40.

The working table 60 is mounted to the base seat 11 and is oriented toward the cutter unit 40. The working table is situated below the cutter turret 42 to clamp and position a workpiece (e.g., a wheel not shown). The bottom extendable and contractable cover 70 is a bellows cover that is connected between the post bottom portion 121 and the transverse carrier 20 and that is extendable and contractable along the first direction (Z). To allow the first guide rail unit 110 to be visible, the bottom extendable and contractable cover 70 is shown in a contracted state in the figures.

The top extendable and contractable cover 80 is connected between the post top portion 122 and the transverse carrier 20 and is extendable and contractable along the first direction (Z).

The left extendable and contractable cover 90 is a bellows cover that is connected between the left lateral portion 21 and the cutter unit 40 and that is extendable and contractable along the second direction (X). To allow the second guide rail unit 120 and the second drive unit 50 to be visible, the left extendable and contractable cover 90 is shown in a contracted state. In fact, a right end of the left extendable and contractable cover 90 is connected to the cutter unit 40.

The right extendable and contractable cover 100 is a bellows cover that is connected between the cutter unit 40 and the right lateral portion 22 and that is extendable and contractable along the second direction (X).

The first guide rail 110 provides smooth slide movement of the transverse carrier 20 relative to the upright post 12 along the first direction (Z).

The second guide rail 120 provides smooth slide movement of the cutter unit 40 relative to the transverse carrier 20 along the second direction (X).

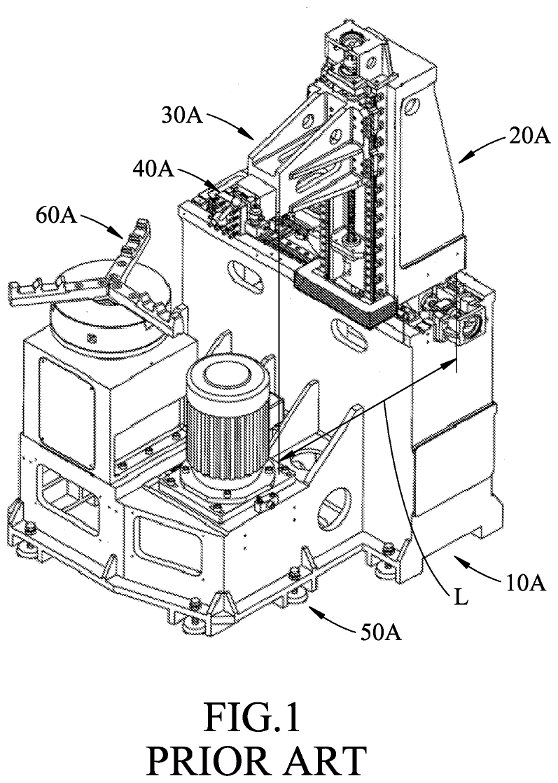

As shown in FIGS. 1 to 5, when the wheel reconditioning apparatus of the disclosure is completed in assembly, the transverse carrier 20 and the cutter unit 40 are situated in front of the support front surface 123. When the first motor 32 is activated, the transverse carrier 20, the cutter unit 40, and the left and right extendable and contractable covers 90, 100 are driven to move along the first direction (Z) relative to the upright post 12 and the working table 60.

When the second motor 52 is activated, the cutter unit 40 is driven to move along the second direction (X) relative to the working table 60, and the workpiece clamped and positioned by the working table 60 is reconditioned by a cutter (not shown) mounted to the cutter turret 42.

Because the transverse carrier 20 is disposed transversely of and slideably along the first direction (Z) on the support front surface 123, and because the cutter unit 40 is disposed slideably along the second direction (X) on the carrier front surface 24, a distance (L′) from the cutter turret 42 to the support front surface 123, where the transverse carrier 20 is supported, is reduced compare to the distance (L) of the prior art cutter turret 40A shown in FIG. 1. Therefore, a bending moment generated at the cutter turret 42 is relatively small, and machining accuracy of the cutter unit 40 can be improved.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A wheel reconditioning apparatus, comprising:
a support unit including a base seat, and an upright post integrally connected atop said base seat and extending along a first direction, said upright post having a support front surface extending along the first direction;
a transverse carrier disposed transversely of and slideably along the first direction on said support front surface, and having a carrier front surface spaced apart from said support front surface;
a first drive unit mounted between said upright post and said transverse carrier to drive said transverse carrier to move along the first direction;
a cutter unit disposed slideably along a second direction transverse to the first direction on said carrier front surface;
a second drive unit connected between said transverse carrier and said cutter unit to drive said cutter unit to move along the second direction; and
a working table mounted to said base seat and oriented toward said cutter unit.

2. The wheel reconditioning apparatus as claimed in claim 1, wherein:
said upright post further has a post bottom portion connected to said base seat, and a post top portion opposite to said post bottom portion along the first direction, said support front surface extending from said post bottom portion to said post top portion; and
said wheel reconditioning apparatus further includes
a bottom extendable and contractable cover connected between said post bottom portion and said transverse carrier and extendable along the first direction, and
a top extendable and contractable cover connected between said post top portion and said transverse carrier and extendable along the first direction.

3. The wheel reconditioning apparatus as claimed in claim 1, wherein said first drive unit includes a first threaded guide rod disposed along the first direction on said upright post proximately of said support front surface, a first motor mounted to said upright post to drive rotation of said first threaded guide rod, and a first nut threadedly connected to said first threaded guide rod and fixed to said transverse carrier.

4. The wheel reconditioning apparatus as claimed in claim 3, wherein said upright post further has an indentation portion indented into said support front surface, said first threaded guide rod being mounted in said indentation portion.

5. The wheel reconditioning apparatus as claimed in claim 1, wherein said second drive unit includes a second threaded guide rod disposed along the second direction on said transverse carrier, a second motor mounted to said transverse carrier to drive rotation of said second threaded guide rod, and a second nut threadedly connected to said second threaded guide rod and fixed to said cutter unit.

6. The wheel reconditioning apparatus as claimed in claim 1, wherein:
said transverse carrier further has a left lateral portion and a right lateral portion opposite to said left lateral portion along the second direction; and
said wheel reconditioning apparatus further includes a left extendable and contractable cover extendable along the second direction and connected between said left lateral portion and said cutter unit, and a right extendable and contractable cover extendable along the second direction and connected between said cutter unit and said right lateral portion.
